(19) United States
(12) Patent Application Publication
(10) Pub. No.: US 2022/0414616 A1
(43) Pub. Date: Dec. 29, 2022

(54) METHODS AND APPARATUS FOR CREATING ASSET RELIABILITY MODELS

(71) Applicant: Copperleaf Technologies Inc., Vancouver (CA)

(72) Inventors: Alejandro ERICKSON, Burnaby (CA); Danilo PRATES DE OLIVEIRA, Vancouver (CA); Guy DRUCE, Vancouver (CA)

(21) Appl. No.: 17/849,021

(22) Filed: Jun. 24, 2022

Related U.S. Application Data
(60) Provisional application No. 63/214,380, filed on Jun. 24, 2021.

(51) Int. Cl. G06Q 10/00; G06Q 10/06; G06Q 30/02

(52) U.S. Cl. CPC G06Q 10/20; G06Q 10/06313; G06Q 30/0203

(57) ABSTRACT

A method, apparatus and system for creating an asset reliability model for at least one physical asset includes receiving data related to the at least one physical asset from at least a selection of at least one data source from which to receive the data related to the at least one physical asset, receiving a selection of at least one type of model to be created, receiving a respective response to at least one guided task or choice configured to prepare the received data, and creating an asset reliability model for the at least one physical asset using a machine learning process based on the received data related to the at least one physical asset, the selection of the model to be created, and the respective response to the at least one guided task or choice.

### CROSS REFERENCE TO RELATED APPLICATIONS

This application claims benefit of and priority to U.S. Provisional Patent application Ser. No. 63/214,380, filed Jun. 24, 2021, which is herein incorporated by reference in its entirety.

### FIELD

The present disclosure relates, generally, to methods and apparatus used for asset management, and more particularly, to methods and apparatus for creating physical asset reliability models by managing local and remote-shared data-sources, guiding the user in data preparation, and applying statistical and Artificial Intelligence analysis. The reliability models can be used in an asset planning and management software system.

### BACKGROUND

Many businesses face challenges in managing large numbers of pieces of equipment or other assets, e.g., utility poles (e.g., power lines), assets on circuits in a transmission network, pipeline, railroad tracks, cable, etc. The assets maintained by a typical larger organization is a complex system that requires maintenance to continue to operate smoothly to provide production for the organization. Furthermore, many organizations have a sufficiently large pool of assets which can make it impossible to maintain production without careful scheduling of maintenance and replacement of various assets.

For example, some organizations, e.g., a power company, can have in excess of thirty thousand assets (e.g., circuits, relays, transformers, etc.) on a plurality of circuits of an electrical transmission network that need to be maintained and sometimes repaired, upgraded, replaced, or refurbished. Some organizations choose to take preemptive steps (e.g., interventions) to minimize a likelihood of failure of an asset. Accordingly, when assets on a circuit of the electrical transmission network need maintenance, for example, one or more segments, e.g., circuits, of the electrical transmission network may need to be disabled for the maintenance to occur, which can be costly for the power company. As can be appreciated, when multiple interventions for a plurality of assets need to be performed, outage costs associated with disabling the multiple segments on the electrical transmission can be even more costly for the power company.

Asset Planning and Management (APM) techniques/software help asset heavy companies, such as utility companies, to evaluate proposed infrastructure projects, forecast capital and maintenance spending, and minimize physical and financial risks in a population of assets. A key capability of APM techniques/software is modeling the reliability of utility assets. Reliability models are used to evaluate risks that would be mitigated by competing management plans. Risk calculations often dominate the valuation of asset management activities, yet they can be very sensitive to small differences in reliability models. As such, accurate and realistic reliability models play an important role in APM.

APM may benefit from coarse models that draw partially upon the experience of consultants and Subject Matter Experts (SMEs), however, these methods are often inaccurate and imprecise when applied on their own. Accurate and precise reliability models must be driven by data, which can include asset registries, failures, condition assessments, maintenance records, sensors, etc., however, utilities typically lack the large volume of high-quality records that are required.

Furthermore, models created ad-hoc by combining SME and consultant recommendations with limited amounts of data analysis are costly and difficult to interpret and reuse correctly. As a result of the high cost and a lack of data, asset heavy companies, such as utility companies, are forced to settle for overly coarse and sometimes inapplicable models that are inaccurate and imprecise.

### SUMMARY

The present disclosure relates, generally, to methods and apparatus used for asset management, and more particularly, to methods and apparatus for creating physical asset reliability models by managing local and remote-shared data-sources, guiding the user in data preparation, and applying statistical and Artificial Intelligence analysis. The reliability models can be used in an asset planning and management software system.

In some embodiments a method for creating an asset reliability model includes receiving data related to the at least one physical asset from at least a selection of at least one data source from which to receive the data related to the at least one physical asset, receiving a selection of at least one type of model to be created, receiving a respective response to at least one guided task or choice configured to prepare the received data related to the at least one physical asset to be used to create the selected model type, and creating an asset reliability model for the at least one physical asset using a machine learning process based on the received data related to the at least one physical asset, the selection of the model to be created, and the respective response to the at least one guided task or choice. In some embodiments, the method can further include allocating resources for performing/scheduling repair/maintenance on the at least one physical asset based on the determined reliability model.

In some embodiments, the method can further include presenting a graphical user interface (GUI) having at least one of a list of data sources on a display device to enable a user to select at least one data source from the list of data sources from which to receive data related to the at least one physical asset, a list of model types to enable a user to select at least one type of model to be created, or at least one guided task or choice to be responded to or followed by a user to prepare at least the received data for creating the at least one reliability model for the at least one physical asset.

In some embodiments, the at least one type of model to be created includes at least one of an end of an asset's economic life model, an unexpected, degraded operation model, an unplanned outage model, an un-planned maintenance model, or a planned maintenance model and the information in the reliability model is used to schedule zero or more interventions for the at least one physical asset including at least allocating resources for performing maintenance on the at least one physical asset.

In some embodiments, the determined reliability model can be automatically or manually updated with a change in data related to the at least one physical asset and previously determined parametric curves and models can be used to assist in creating the asset reliability model for the at least one physical asset.

In some embodiments a non-transitory machine-readable medium has stored thereon at least one program, the at least one program including instructions which, when executed by a processor, cause the processor to perform a method in a processor based system for creating an asset reliability model for at least one physical asset, including receiving data related to the at least one physical asset from at least a selection of at least one data source from which to receive the data related to the at least one physical asset, receiving a selection of at least one type of model to be created, receiving a respective response to at least one guided task or choice configured to prepare the received data related to the at least one physical asset to be used to create the selected model type, and creating an asset reliability model for the at least one physical asset using a machine learning process based on the received data related to the at least one physical asset, the selection of the model to be created, and the respective response to the at least one guided task or choice.

In some embodiments, a system for creating an asset reliability model for at least one physical asset, includes at least one data source, and a computing device comprising a processor and a memory having stored therein at least one program, the at least one program including instructions. In such embodiments, the at least one program, when executed by the processor, cause the computing device to perform a method including receiving data related to the at least one physical asset from at least a selection of at least one data source from which to receive the data related to the at least one physical asset, receiving a selection of at least one type of model to be created, receiving a respective response to at least one guided task or choice configured to prepare the received data related to the at least one physical asset to be used to create the selected model type, and creating an asset reliability model for the at least one physical asset using a machine learning process based on the received data related to the at least one physical asset, the selection of the model to be created, and the respective response to the at least one guided task or choice

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 is a diagram of an asset management device, in accordance with an embodiment of the present disclosure;

FIG. 2 depicts an example of a user interface for configuring data sources and integrations, in accordance with an embodiment of the present disclosure;

FIG. 3 depicts an example of user interface for selecting different model choices, in accordance with an embodiment of the present disclosure;

FIG. 4A depicts examples of a user interface for data preparation criteria, in accordance with an embodiment of the present disclosure;

FIG. 4B depicts examples of a user interface for data preparation criteria, in accordance with an embodiment of the present disclosure;

FIG. 5 depicts an example of a user interface for model creation outcomes, in accordance with an embodiment of the present disclosure.

FIG. 6 depicts a flow diagram of a method for creating physical asset reliability models in accordance with an embodiment of the present principles.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

The following detailed description describes techniques (e.g., methods, processes, and systems) for asset management, and more particularly, to methods and apparatus for creating physical asset reliability models by, in some embodiments, managing local and remote-shared data-sources, guiding the user in data preparation, and applying statistical and Artificial Intelligence analysis. The determined reliability models of the present principles can be used in asset intervention such as asset planning and management software systems and the like. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Embodiments consistent with the present principles introduce an Asset Reliability Model Creation (ARMC) system that is configured to guide the user to create one or more reliability models, in some embodiments, in multiple high-level stages. Exemplary stages may consist of:
1. Data-source selection stage: The ARMC system receives a user selection of a set of local and/or remote-shared data sources, and optionally receives additional data from the user.
2. Model choice stage: The ARMC system receives a user selection of a type of real-world event that the user wants to model. Examples include the end of an asset's economic life, unexpected degraded-operation, unplanned outages, un-planned maintenance vs planned maintenance.
3. Data preparation stage: The ARMC system analyzes the selected data source(s) and model choice and provides the user with a list of guided tasks and choices that shape the data used to create the desired model.
4. Model creation stage: The ARMC system processes the data prepared in Stage 3 using statistical and/or AI techniques, displays the resulting model and related information for evaluation, and makes the model available for use.

Embodiments consistent with the inventive multi-stage ARMC system are described in detail below with respect to the figures.

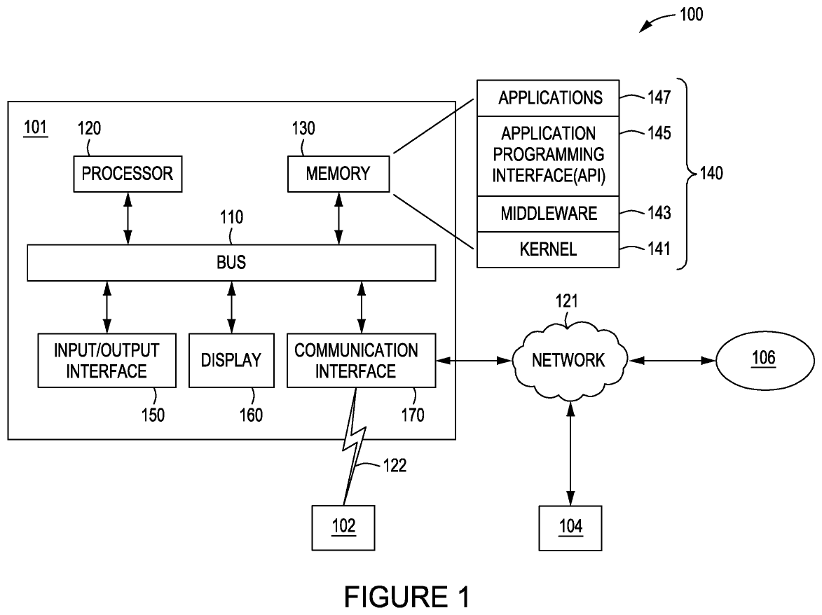

Referring to FIG. 1, a diagram of an Asset Reliability Model Creator (ARMC) system 100 embodied in an electronic device 101 (e.g., desktop computer, PC, mobile phone, laptop, server, cloud-based server, or other suitable computing device) that is configured to operate in a network environment is shown. The electronic device 101 includes a bus 110, a processor 120, a memory 130, an input/output device 150, a display 160, and a communication interface 170. At least one of the above described components may be omitted from the electronic device 101 or another component may be further included in the electronic device 101.

The bus 110 may be a circuit connecting the above described components 120, 130, and 150-170 and transmitting communications (e.g., control messages and/or data) between the above described components.

The processor 120 may include one or more of a CPU, an application processor (AP), and/or a communication processor (CP). The processor 120 controls at least one of the other components of the electronic device 101 and/or processing data or operations related to communication. The processor 120, for example, can use one or more control algorithms (asset reliability model creation algorithms), which can be stored in the memory 130, to perform a method for asset reliability model creation and use, as will be described in greater detail below.

The memory 130, which can be a non-transitory computer readable storage medium, may include volatile memory and/or non-volatile memory. The memory 130 stores data or commands/instructions related to at least one of other components of the electronic device 101. The memory 130 stores software and/or a program module 140. For example, the program module 140 may include a kernel 141, middleware 143, an application programming interface (API) 145, application programs (or applications) 147, etc. The kernel 141, the middleware 143 or at least part of the API 145 may be called an operating system (OS).

The kernel 141 controls or manages system resources (e.g., the bus 110, the processor 120, the memory 130, etc.) used to execute operations or functions of other programs (e.g., the middleware 143, the API 145, and the applications 147). The kernel 141 provides an interface capable of allowing the middleware 143, the API 145, and the applications 147 to access and control/manage the individual components of the electronic device 101, e.g., when performing an asset reliability model creation routine or operation.

The middleware 143 may be an interface between the API 145 or the applications 147 and the kernel 141 so that the API 145 or the applications 147 can communicate with the kernel 141 and exchange data therewith. The middleware 143 processes one or more task requests received from the applications 147 according to a priority. For example, the middleware 143 assigns a priority for use of system resources of the electronic device 101 (e.g., the bus 110, the processor 120, the memory 130, etc.) to at least one of the applications 147. For example, the middleware 143 processes one or more task requests according to a priority assigned to at least one application program, thereby performing scheduling or load balancing for the task requests. For example, when executing the applications 147, which can include an asset reliability model creation application (e.g., managing local and remote-shared data-sources, guiding the user in data preparation, and applying statistical and Artificial Intelligence analysis), different priorities can be assigned to one or more tasks of the asset reliability model creation application so that a task having a higher priority can be performed prior to a task having a lower priority, e.g., storing data input by a user can have a relatively high priority, while updating information of an asset in a database of the memory 130 can have a relatively low priority.

The API 145 may be an interface that is configured to allow the applications 147 to control functions provided by the kernel 141 or the middleware 143. The API 145 may include at least one interface or function (e.g., instructions) for file control, window control, image process, text control, or the like.

The input/output device 150 is capable of transferring instructions or data, received from the user or one or more remote (or external) electronic devices 102, 104 or the server 106, to one or more components of the electronic device 101. For example, the input/output device 150 can receive an input, e.g., entered via the display 160, a keyboard, or verbal command, from a user. The input can include information, e.g., a user selection of a set of local and/or remote-shared data sources, or a user selection of a type of real-world event that the user wants to model. Examples include the end of an asset's economic life, unexpected degraded-operation, unplanned outages, un-planned maintenance vs planned maintenance.

The input/output device 150 is capable of outputting instructions or data, which can be received from one or more components of the electronic device 101, to the user or remote electronic devices.

The display 160 may include a liquid crystal display (LCD), a flexible display, a transparent display, a light emitting diode (LED) display, an organic LED (OLED) display, micro-electromechanical systems (MEMS) display, an electronic paper display, etc. The display 160 displays various types of content (e.g., texts, images, videos, icons, symbols, etc.). The display 160 may also be implemented with a touch screen. In this case, the display 160 receives touches, gestures, proximity inputs or hovering inputs, via a stylus pen, or a user's body.

The communication interface 170 establishes communication between the electronic device 101 and the remote electronic devices 102, 104 or a server 106 (which can include a group of one or more servers and can be a cloud-based server) connected to a network 121 via wired or wireless communication. The electronic device 101 may employ cloud computing, distributed computing, or client-server computing technology when connected to the server 106.

Wireless communication may employ, as cellular communication protocol, at least one of long-term evolution (LTE), LTE Advance (LTE-A), code division multiple access (CDMA), wideband CDMA (WCDMA), universal mobile telecommunications system (UMTS), wireless broadband (WiBro), and global system for mobile communication (GSM), which can be used for global navigation satellite systems (GNSS). The GNSS may include a global positioning system (GPS), global navigation satellite system (Glonass), Beidou GNSS (Beidou), Galileo, the European global satellite-based navigation system, according to GNSS using areas, bandwidths, etc. Wireless communication may also include short-range communication 122. Short-range communication may include at least one of wireless fidelity (Wi-Fi), Bluetooth (BT), near field communication (NFC), and magnetic secure transmission (MST).

Wired communication may include at least one of universal serial bus (USB), high definition multimedia interface (HDMI), recommended standard 232 (RS-232), and plain old telephone service (POTS). The network 121 may include at least one of the following: a telecommunications network, e.g., a computer network (e.g., local area network (LAN) or wide area network (WAN)), the Internet, and a telephone network.

Each of the remote electronic devices 102 and 104 and/or the server 106 may be of a type identical to or different from that of the electronic device 101. All or some of the operations performed in the electronic device 101 may be performed in the remote electronic devices 102, 104 or the server 106. When the electronic device 101 has to perform some functions or services automatically or in response to a request (e.g., when using the asset management application), the electronic device 101 may make a request for performing at least some functions relating thereto to the remote electronic device 102 or 104 or the server 106, instead of performing the functions or services by itself. The remote electronic devices 102, 104 or the server 106 may execute the requested functions or the additional functions, and may deliver a result of the execution to the electronic device 101. The electronic device 101 may provide the received result as it is or additionally process the received result and provide the requested functions or services. To achieve this, for example, cloud computing, distributed computing, or client-server computing technology may be used.

An asset reliability model creation application (e.g., the application 147) includes a plurality of instructions that are executable by the processor 120 using the API 145. The asset management application can be downloaded from the server 106 (or the remote electronic device 104) via the Internet over the network 121 (or from the remote electronic device 102 via, for example, the short-range communication 122) and installed in the memory 130 of the electronic device 101.

The asset reliability model creation application 14 goes through multiple stages to create the asset reliability model to be used with an APM, for example. In some embodiments, Stages 1-4 apply to an Asset Modeling Session. In some embodiments, new Sessions can be created, and existing Sessions can be loaded through a ARMC user interface. In some embodiments, Sessions can auto-save throughout Stages 1-4. Although four stages that the asset reliability model creation application goes through are described below, in some embodiments, more or less stages may be used.

As depicted in FIG. 1, an ARMC system of the present principles, such as the ARMC system 100 of FIG. 1, can include/interact with at least one optional sensor 175, which can provide inputs to the ARMC system 100. For example, in some embodiments of the present principles, at least some information regarding asset parameters can be determined using sensors. For example, the ARMC system 100 of FIG. 1 can receive information from at least one sensor 175, which in some embodiments include at least one a camera capable of capturing images of assets and minor assets comprising an asset. In such embodiments, the software and/or a program module 140 of the ARMC system 100 of FIG. 1 can be configured to determine, from images received from the at least one sensor 175, asset information including but not limited to a number of assets, asset types, a relationship between assets and/or minor assets, a condition (e.g., wear and tear) of the assets, asset failure(s), and the like. In some embodiments of the present principles, sensors can include cameras, vibrational sensors for capturing vibrational data from assets, temperature sensors for capturing temperature information from assets, and any other sensor that can capture asset parameters. Such sensor information can be used to determine asset reliability models in accordance with the present principles.

In some embodiments of the present principles, an ARMC system of the present principles, such as the ARMC system 100 of FIG. 1, can implement at least one machine learning process for interpreting the information/data from the at least one sensor 175, for determining an asset reliability model in accordance with the present principles. For example, in some embodiments of the present principles, the software and/or program module 140 can include a machine learning (ML) process (not shown) to interpret asset information, including asset information captured by the at least one sensor 175, for use in determining an asset reliability model in accordance with the present principles. In some embodiments, the ML process can include a multi-layer neural network comprising nodes that are trained to have specific weights and biases. In some embodiments, the ML process of, for example, the software and/or program module 140 employs artificial intelligence techniques or machine learning techniques to analyze asset related content/data, including data from sensors, such as the at least one sensor 175, to determine asset information. That is, in some embodiments, in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Se2oSeq’ Recurrent Neural Network (RNNs)/Long Short Term Memory (LSTM) networks, Convolution Neural Networks (CNNs), graph neural networks applied to the abstract syntax trees corresponding to the sequential program application, and the like. In some embodiments a supervised ML classifier could be used such as, but not limited to, Multilayer Perceptron, Random Forest, Naive Bayes, Support Vector Machine, Logistic Regression and the like.

The ML process can be trained using thousands to millions of instances of asset related data, including sensor data, to identify asset information to be used to generate an asset reliability model. For example, many instances of image data from a camera sensor can be used to train an ML process of the present principles how an asset looks at a specific level of degradation or how an asset looks at a point of failure or at a certain amount of time before failure. Over time, the ML process learns to look for specific attributes in the content to provide asset information, such as a condition/status of assets, which can be used to in determining asset reliability models in accordance with the present principles.

### Stage 1—Data-source Selection

In stage 1, the ARMC system 100 receives information/data regarding assets of interest. In some embodiments, the asset information can be received based on a user selection of, a set of local and/or remote-shared data sources. Alternatively or in addition, the ARMC system 100 can select/elect to obtain asset information/data from a storage accessible to the ARMC system 100.

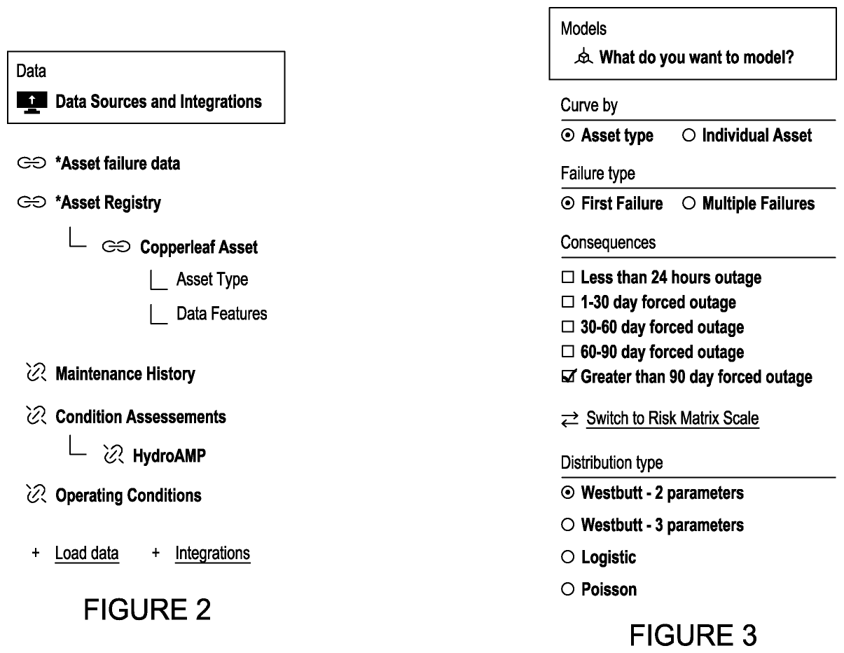

The ARMC system 100 has access to multiple sources and types of data that can be used to create reliability models. FIG. 2 depicts an example of a user interface for configuring data sources and integrations. Example types of data sources include, but are not limited to:
Asset registry: asset nameplate information, asset type, in-service date, retirement date, service, location, manufacturer, and other information about the asset and its usage.
Maintenance history: time-series with type of intervention performed, notes, etc.
Condition assessment history: time-series data of condition assessments, including physical inspections, performance, tests, and measurements results.
Asset failure history: time-series with type or severity of failure, length of outage, notes, etc.
Operation history: time-series with information such as number of start/stops, volumes, re-routings, operating restraints, loading, duration outside normal operation, forced outages, electrical, mechanical, thermal, and environmental stresses, etc.
Example data sources:
Uploaded tabulated data such as Excel workbooks or comma-separated values, stored in the ARMC database with meta-data that describes the quality and/or interpretation of the data.
Live connections to third-party applications such as GIS, asset registries, and other asset-management systems.
Integrations with third-party applications that provide historical asset data upon request.
Cloud-based or distributed data-storage devices containing anonymized asset data from a community of clients.
Live connections to other ARMC application instances that can provide plain or anonymized data, per system configuration, which may be raw or prepared for a specific type of model.
Sensor data from sensors proximate the assets for capturing asset data.

The ARMC system 100 receives/collects data from a variety of sources, which may originate from differing organizational cultures, and, in some embodiments, normalizes the data to a common template. In some embodiments, this process can require additional user input. In some embodiments, information will be extracted from unstructured data, and converted into a structured format using machine learning techniques.

### Stage 2—Model Choice

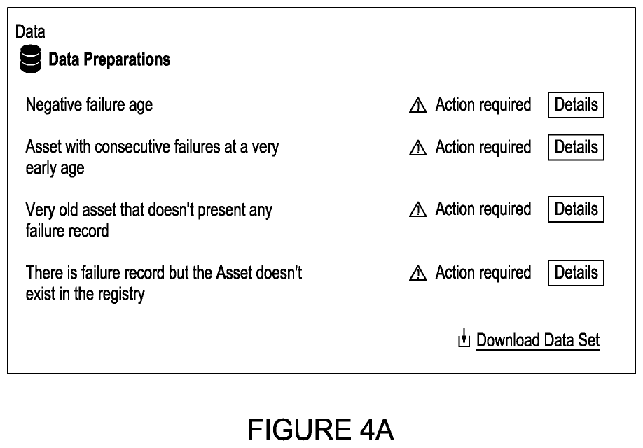

In Stage 2, the ARMC system 100 receives/selects a type of model to create. In some embodiments, an ARMC system 100 can select a real-world event to be modelled such as the end of an asset's economic life, unexpected degraded-operation, unplanned outages, un-planned maintenance vs planned maintenance. In some embodiments, a type of model to create can be dependent upon the asset information/data received in the previous step. In some embodiments, a user, via a user interface, selects a type of model to create. FIG. 3 is an example of a user interface for selecting different model choices.

For example, in some embodiments, APM software users often wish to model the time to the first failure of a certain type to calculate risks associated with that failure mode, over a set of assets (e.g., Model Choice 1). This choice of model may utilize the following information:
The set of assets, such as those matching a pre-defined asset type or some specific nameplate features.
The failure mode or type, e.g., degraded operation or catastrophic failure requiring replacement of the asset.
The analysis method, such as fitting a parametric distribution (Weibull, Exponential, Gamma, Logistic, Poisson, etc.).

In other embodiments, APM software users may wish to model the proportion of assets that will exhibit a repairable failure each year (e.g., Model Choice 2). The additional required information is similar to the above with respect to Model Choice 1. Additionally, the user should indicate whether consecutive failures are independent.

Still, in other embodiments, APM software users may wish to model time-to-event (TTE), as in the first example above, but with finer granularity (e.g., Model Choice 3). The user will specify additional features, including nameplate and historical time-series data, that the ARMC can use to tailor TTE distributions for subsets of the assets.

The ARMC is an extensible system in which many different sorts of models can be implemented. It is not limited to the model choices described above.

### Stage 3—Data Preparation

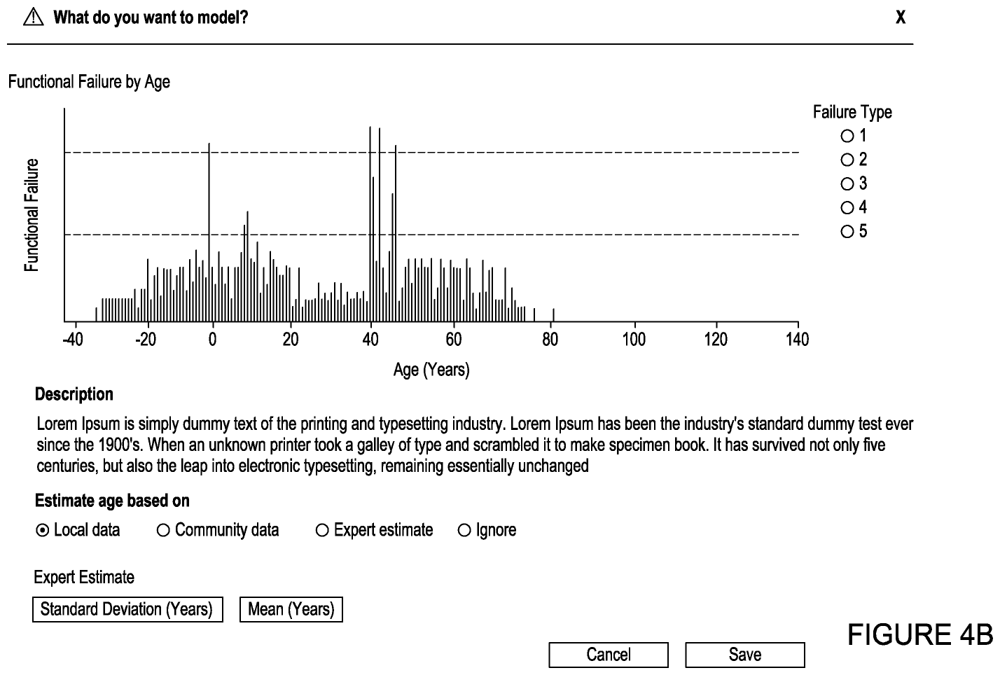

In Stage 3, the ARMC system 100 analyzes the selected data source(s) and model choice and implements processes to shape the data that will be used to create the selected model. For example, in some embodiments, the ARMC system 100 provides a user with a list of guided tasks and choices that shape the data used to create the desired model. FIGS. 4A and 4B are examples of a user interface for data preparation criteria.

The ARMC system 100 analyzes the selected data sources in consideration of the model choice and lists tasks required of the user to prepare the data for model creation. Data preparation tasks can vary widely. However, in some embodiments, data preparation tasks can fall into one or more of three categories: interpretation, quality control, and SME estimation. In some embodiments, tasks can be guided and illustrated with visual aids that help the user understand the effects of their choices.

Data preparation example 1, interpretation. The user chooses to model end-of-economic life, and the data set contains several asset “retirement” dates. The data preparation task can be implemented to indicate whether the “retirements” should be considered end-of-economic life or not.

Data preparation example 2. The user chooses to model end-of-economic life and there are failure records for assets not in the asset-registry. This indicates that there were assets that failed or were replaced by new assets, but not how old they were when they were replaced, since they have no in-service date. The user can provide an SME-estimated distribution of the age at first failure for the non-registry assets, or they can choose to ignore them. The ARMC system 100 can then synthesize in-service dates by drawing from the specified distribution.

Data preparation example 3. The user chooses to model repairable failures, but the data contains minor failures that occurred in close succession. The user can choose how close successive failures can be without being considered as a single failure.

Data preparation example 4. A data source may present data points that appear unreliable, such as older assets for which early failure or maintenance records do not exist. The user can help the ARMC system 100 identify this type of unreliable data by limiting the analysis to newer assets.

Custom data preparations tasks. The user can apply customized data preparation tasks by manipulating individual data points and/or sets of data points. At any time in the data preparation process, the prepared data can be exported to Excel or comma-separated value formats.

In some embodiments, if the user desires, prepared data sets may be shared with the user-community, either in a plain or anonymized form, so that they can be selected by other ARMC system community users for use in other models of the same or similar type.

In addition, at this data-preparation stage the input data set may be augmented by data points that are synthesized from SME inputs. In some embodiments, specific techniques for gathering and using SME inputs and the functionality of the ARMC can include but are not limited to:
Employ plain-language questionnaires to elicit estimates that an SME can provide easily and/or come up with intuitively.
Cover a range of related asset classes with few questions/questionnaires.
Use an iterative feedback loop in which the SMEs can update their estimates after seeing the generated model.

In embodiments of the present principles, SME inputs are not necessarily elicited only at the data preparation step but can be elicited through an ongoing relationship between the ARMC system of the present principles and a group of SMEs. In some embodiments, for interacting with an ARMC system of the present principles, an SME-user of an ARMC instance of the present principles can iterate through the following steps:
The SME can rate their expertise in a list of areas that can be listed by the ARMC. For example, in some embodiments the rating can be from 1 (no expertise) to 5 (very high expertise).
The SME can receive notifications of questionnaires for which to provide responses. In some embodiments, the questionnaires can be queued in priority order.
The SME can then provide responses to the questionnaires.

In some embodiments, the above SME steps can be performed iteratively. For example, the SME can update their self-assessment any time, and the other steps can be repeated for a same questionnaire to refine the SME inputs. A repeated questionnaire can be accompanied by some evidence that can influence the SME's estimate, such as the output of a related ARMC asset model, or the estimates of the SME's peers. The SME can then re-answer the questionnaire to update their input. In some embodiments, the degree to which the ARMC iterates upon the SME inputs can be adjusted and can also depend on how much SME consensus or uncertainty there is in each model.

The precise content of an SME questionnaire can vary, however it is possible to derive a probability distribution of an event and some confidence weighting, which can be partially taken from the SME's self-profile configuration created in the first step. In some embodiments it is possible to derive information, such as a distribution, on the parameters of a probability distribution of the event being modeled.

An asset modeler (AM) user of the ARMC of the present principles can request SME inputs at the Data Preparation Stage of a modeling session, at which point the ARMC can automatically identify, and process previously collected inputs related to the assets being modelled. The ARMC can continuously collect SME inputs for various asset types (and other relevant data such as environment) and, as such, the AM can expect to have some data to begin their work of performing modeling. Alternatively or in addition, the AM can initiate new requests for SME inputs at this Stage which can be incorporated into a determined model and iterated upon later. The newly requested SME inputs can also be stored for other relevant modeling sessions. More details are provided in the Model Creation section below.

### Stage 4—Model Creation

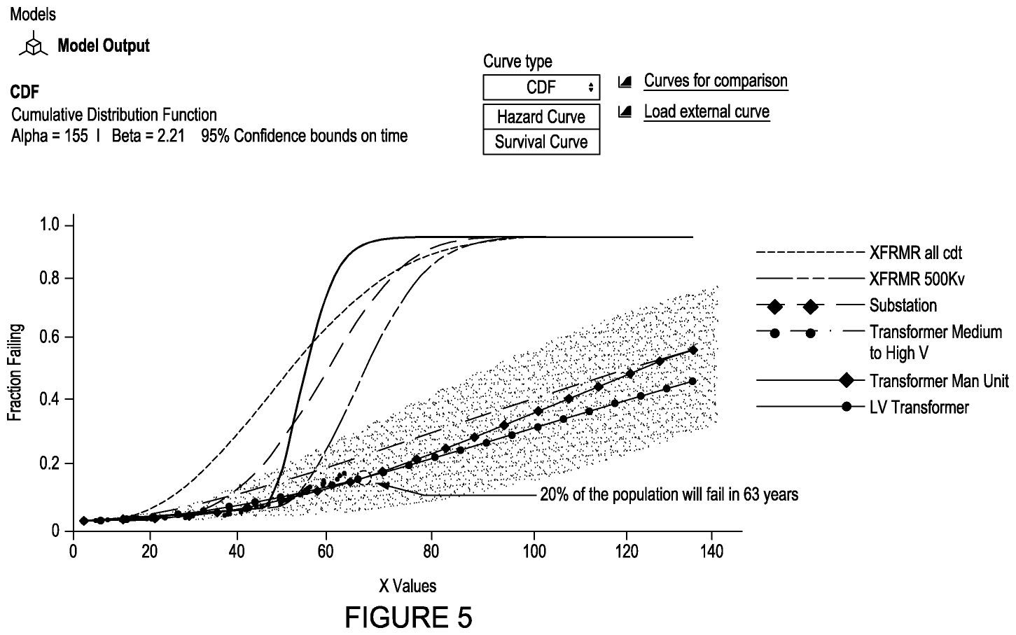

In some embodiments, at Stage 4, the ARMC system 100 processes the data prepared in Stage 3, along with information from Stages 1-2, to determine an asset reliability model. In some embodiments, the ARMC system 100 processes the data prepared in Stage 3 using statistical and/or AI techniques. The ARMC system 100 can then display the resulting reliability model and related information for evaluation and can make the model available for use. FIG. 5 is an example of a user interface for model creation outcomes.

Reliability models of the present principles can be created using a variety of methods. Models can also be updated live as asset data changes and one or more visual representations of the model can be displayed to the user. In some embodiments, the simplest visualizations are of the event probabilities themselves, but the ARMC system 100 can also demonstrate the simulated effect of the model on a hypothetical set of assets over time. This helps the user relate the model to the intuition and expertise they have around the assets they are working with. Alternatively or in addition, the user can visually and quantitatively compare the created model to models created by other means, which, in some embodiments can obtained by the ARMC of the present principles via manual upload, third party integration, or the ARMC system user-community. That is, in some embodiments, previously determined parametric curves, models and the like determined by an ARMC system of the present principles or other community members, can be implemented to assist in determining an asset reliability model of the present principles.

Model creation example 1. Many techniques can be employed in a reliability analysis of the present principles, including parametric modelling (e.g., Weibull, Exponential etc.), Kaplan-Meier, Cox proportional hazards, etc. In some embodiments, techniques in Bayesian reliability analysis can also be employed, including those using numerical methods such as Markov chain Monte Carlo (MCMC).

Model creation example 2. AI and Machine Learning can be leveraged, such as with Recurrent Neural Networks, to analyze and find co-variates in asset historical data or interpret natural language notes as specific types of events.

Model creation example 3. Federated analysis can be done to protect the privacy and security of data sources while sharing results with the user-community. Raw data is processed privately by individual client ARMC systems 100, and the resulting models are shared with the user-community. User-community models are requested and collected, where they are either combined into a new analysis or simply used as input to a data-preparation step.

In some embodiments, when a satisfactory asset reliability model has been created, the asset reliability model can be made available for implementation. For example, in some embodiments, when a user is satisfied with a created asset reliability model, the asset reliability model can be exported to various formats, or provided directly to an APM software system through a third-party integration.

Again referring to SME inputs, at the Model Creation Stage, the ARMC system of the present principles can apply all available and relevant SME inputs, in some embodiments stored as a set of questionnaire responses, to an asset reliability model according to the following four high-level steps:
1) Generating a distribution of probabilities of event from each questionnaire response.
2) Combining the probability distributions and confidence weighting into a “Combined SME distribution”.
3) Sampling from the combined SME distribution to synthesize data points.
4) Combining the synthesized and original event data points

In accordance with the present principles, the combining of the probability distributions and confidence weighting can be performed in a variety of ways. In some embodiments, a linear opinion pool distribution p(x) is a weighted arithmetic mean according to equation one (1), which follows:

p(x)=Σᵢwᵢpᵢ(x), (1)

wherein the sum of the weights wᵢ is 1. Similarly, the combining of the probability distributions and confidence weighting of the present principles can apply a logarithmic opinion pool, using a weighted geometric mean rather than a weighted arithmetic mean. In some embodiments, the weights themselves can be computed from each SME's self-evaluated confidence, additional self-evaluations provided as questionnaire responses, and additional analysis of the SME's historical usage of the ARMC. In such embodiments, all computed weights are normalized to 1.

In some embodiments, the generation of probability distributions from questionnaire responses of the present principles focuses on the contents of the questionnaire itself. For example, in some embodiments, a PERT distribution from a three-point estimate is specified as “min”, “max”, and “most likely” values for the time to the event that the ARMC system is attempting to model. In an example embodiment, a questionnaire eliciting 3-point estimates for the reliability of a family of related asset classes can include the following questions:
1) What is the event=typical replacement age of an asset type=power pole, material=cedar, location=coastal? Min ______, Max ______, Most likely ______.
2) (optional) By what factor does setting material=fir affect your estimate in Question 1? +/−______%,
3) Nn (optional) By what factor does setting location=inland affect your estimate in Question 2? +/−______%,
4) (optional) By what factor does setting location=inland affect your answer in Question 1? +/−______%,
5) (optional) What level of confidence do you have in your responses: 1(not confident) to 5(very confident) ______.

Note that in the embodiment described above, only a response to Question 1 is required. Blank responses (or an unsubmitted questionnaire) to Questions 2-4 can imply that the SME cannot provide an estimate, for example, the SME may not know the answer or they may find that the question is not answerable because it makes unreasonable assumptions. The example illustrates how questions for multiple asset types can be tied together, but this is not a requirement. The questionnaire could instead prompt for 3-point estimates for each material and location combination.

In the example for the questionnaire above, suppose the related asset classes are fir or cedar power-poles that are situated on the coast or inland, making up four distinct combinations and the event to model is “typical replacement age”. It is assumed that the material and location types can be interpreted unambiguously by the questionnaire respondent.

Table 1 below depicts two different responses from, for example, two questionnaire respondents for the example questionnaire described above. From the two questionnaire responses PERT distributions can be generated for four related asset classes. In the case of inland fir power-poles the three-point estimate is combined and modifiers are applied from Q2 and Q3, which amount to 0.9*1.05=0.945. In Table 1, SME A's responses yield min=40*0.945, max=80*0.945, most likely=50*0.945. SME B's responses yield min=45*0.9, max=75*0.9, most likely=50*0.9. In Table 1, Respondents A and B provided a confidence of 4 and 5, respectively, which yield normalized weights of 4/9 and 5/9. We now have the required normalized weights and PERT distributions required to execute Step 2 of applying SME inputs to an asset model, described above. There are other distributions that can be parametrized by three-point estimates, including the triangle distribution and the modified PERT distribution.

TABLE 1

| | | | | Q2 | Q3 | Q4 | |
|---|---|---|---|---|---|---|---|
| | | | Most | (fir, | (fir, | (cedar, | |
| SME | Min | Max | Likely | coastal) | inland) | coastal) | Confidence |
| A | A | 40 | 80 | 50 | −10% | +5% | −5% |
| B | B | 45 | 75 | 50 | −10% | 0% | −5% |

The example questionnaire and combination techniques for Step 2, above, include sufficient information to complete one iteration of Steps 1-4 of applying SME inputs to an asset model, described above, enabling the ARMC to generate a model based on combined real and synthesized failure data. The model and questionnaire answers can then be sent to SMEs A and B who can adjust their questionnaire answers. For example SME A can depict the model and update the Question 1 answer to 50, then the PERT distribution for SME A can be re-generated from the latest update such that min=50*0.945, and the model is recomputed. If an asset modeler (AM) of the present principles determines that a model is satisfactory, the above described iterative SME input process can be terminated.

For example, interpretation and judgement of the model can be carried out by the AM and associated SMEs by directly viewing information displayed by the ARMC system, as well as by applying the model to an APM system and viewing the effect that the newly applied model has on risk calculations in the APM system. The ARMC system facilitates judgement of the model by demonstrating the model's effect on specific assets which may be selected by a user, or which may otherwise be familiar to an AM or SME user.

In accordance with some embodiments, asset reliability models determined for the physical assets can be implemented to perform interventions on at least the physical assets. For example, in some embodiments information associated with the asset reliability models of the present principles can be used to schedule zero or more interventions for the at least one physical asset including at least allocating resources for performing and/or scheduling maintenance/repair on at least one physical asset based on the determined reliability model. For example in some embodiments, an APM system can rely on asset reliability models of the present principles and associated risk calculations to forecast costs and benefits of carrying out certain plans. These plans may include things like vehicle fleet replacements, electrical power transformer upgrades, nuclear reactor refurbishments and the like. In such systems, comparisons of costs and benefits are used to guide and justify funding decisions within the organization and funding requests to external bodies such as governments. An accurate asset reliability model of the present principles helps users make sound decisions and take actions to fund the asset lifecycle, thereby mitigating risks to acceptable levels while optimizing the cost of doing so.

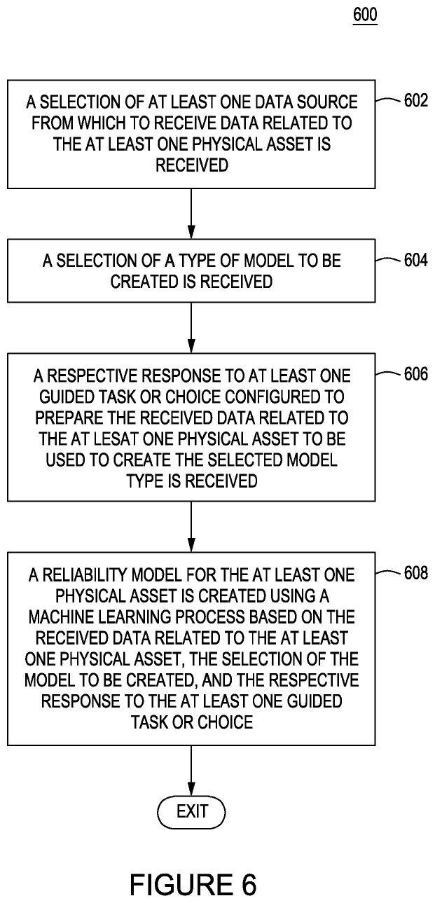

FIG. 6 depicts a flow diagram of a method 600 for creating asset reliability models for at least one physical asset in accordance with an embodiment of the present principles. The method 600 can begin at 602 during which data related to at the at least one physical asset is received from at least a selection of at least one data source from which to receive the data related to the at least one physical asset. As described above, in some embodiments of the present principles, a graphical user interface (GUI) can be implemented to present on a display device a menu interface including data sources for providing data related to the at least one physical asset from which a user can select. As also described above, in some embodiments, an ARMC system of the present principles can select to receive asset related data from a storage device accessible to the ARMC system. The method 600 can proceed to 604.

At 604, a selection of a type of model to be created is received. As described above, in some embodiments of the present principles, a GUI can be implemented to present on a display device a menu interface including types of models that can be created for the physical assets from which a user can select. In some embodiments, the types of models that are depicted on the interface for user selection can depend on the data provided for the physical assets. Even further, an ARMC system of the present principles can select a type of model to be created based on data provided for the physical assets and can also select the type of model to be created from model types stored in a storage device accessible to the ARMC system. The method 600 can proceed to 606.

At 606, a respective response to at least one guided task or choice configured to prepare the received data related to the at least one physical asset to be used to create the selected model type is received. As described above, in some embodiments of the present principles, a GUI can be implemented to present on a display device at least one guided task or choice to be responded to or followed by a user to prepare at least the received data for creating at least one reliability model for the at least one physical asset. The method 600 can proceed to 608.

At 608, a reliability model for the at least one physical asset is created using a machine learning process based on the received data related to the at least one physical asset, the selection of the model to be created, and the respective response to the at least one guided task or choice. The method 600 can be exited.

While the foregoing is directed to embodiments of the present disclosure, other and further embodiments of the disclosure may be devised without departing from the basic scope thereof.

What is claimed:

1. A method for creating an asset reliability model for at least one physical asset, comprising:
receiving data related to the at least one physical asset from at least a selection of at least one data source from which to receive the data related to the at least one physical asset;
receiving a selection of at least one type of model to be created;
receiving a respective response to at least one guided task or choice configured to prepare the received data related to the at least one physical asset to be used to create the selected model type; and
creating an asset reliability model for the at least one physical asset using a machine learning process based on the received data related to the at least one physical asset, the selection of the model to be created, and the respective response to the at least one guided task or choice.

2. The method of claim 1, further comprising:
presenting a graphical user interface (GUI) having a list of data sources on a display device to enable a user to select at least one data source from the list of data sources from which to receive data related to the at least one physical asset.

3. The method of claim 1, further comprising:
presenting a GUI on a display device having a list of model types to enable a user to select at least one type of model to be created.

4. The method of claim 3, wherein the model types in the list are dependent on the received data related to the at least one physical asset.

5. The method of claim 1, further comprising:
presenting a GUI on a display device having at least one guided task or choice to be responded to or followed by a user to prepare at least the received data for creating the at least one reliability model for the at least one physical asset.

6. The method of claim 1, wherein the data related to the at least one physical asset is received from at least one of a user, a device having historical data related to the at least one physical asset or at least one sensor having captured data related to the at least one physical asset.

7. The method of claim 1, further comprising:
using information in the reliability model to schedule zero or more interventions for the at least one physical asset including at least allocating resources for performing maintenance on the at least one physical asset.

8. The method of claim 1, wherein the at least one type of model to be created includes at least one of an end of an asset's economic life model, an unexpected degraded operation model, an unplanned outage model, an un-planned maintenance model, or a planned maintenance model.

9. The method of claim 1, wherein preparing the received data comprises at least one of an interpretation of the received data, performing quality control of the received data, or a subject matter expert (SME) evaluation of the received data.

10. The method of claim 9, wherein the SME provides the evaluation of the received data via at least one questionnaire.

11. The method of claim 1, further comprising at least one of manually or automatically updating the determined reliability model with a change in data related to the at least one physical asset.

12. The method of claim 1, further comprising;
using previously determined parametric curves and models to assist in creating the asset reliability model for the at least one physical asset.

13. The method of claim 1, wherein creating an asset reliability model for the at least one physical asset comprises techniques includes at least one of parametric modelling, Kaplan-Meier, Cox proportional hazards, or Bayesian reliability analysis including a Markov chain Monte Carlo numerical method.

14. A non-transitory machine-readable medium having stored thereon at least one program, the at least one program including instructions which, when executed by a processor, cause the processor to perform a method in a processor based system for creating an asset reliability model for at least one physical asset, comprising:
receiving data related to the at least one physical asset from at least a selection of at least one data source from which to receive the data related to the at least one physical asset;
receiving a selection of at least one type of model to be created;
receiving a respective response to at least one guided task or choice configured to prepare the received data related to the at least one physical asset to be used to create the selected model type; and
creating an asset reliability model for the at least one physical asset using a machine learning process based on the received data related to the at least one physical asset, the selection of the model to be created, and the respective response to the at least one guided task or choice.

15. The machine-readable medium of claim 14, wherein the method further comprises:
presenting a graphical user interface (GUI) having a list of data sources on a display device to enable a user to select at least one data source from the list of data sources from which to receive data related to the at least one physical asset.

16. The machine-readable medium of claim 14, wherein the method further comprises:
presenting a GUI on a display device having a list of model types to enable a user to select at least one type of model to be created.

17. The machine-readable medium of claim 16, wherein the model types in the list are dependent on the received data related to the at least one physical asset.

18. The machine-readable medium of claim 14, wherein the method further comprises:
presenting a GUI on a display device having at least one guided task or choice to be responded to or followed by a user to prepare at least the received data for creating the at least one reliability model for the at least one physical asset.

19. The machine-readable medium of claim 14, wherein the data related to the at least one physical asset is received from at least one of a user, a device having historical data related to the at least one physical asset or at least one sensor having captured data related to the at least one physical asset.

20. The machine-readable medium of claim 14, wherein the method further comprises:
using information in the reliability model to schedule zero or more interventions for the at least one physical asset including at least allocating resources for performing maintenance on the at least one physical asset.

21. The machine-readable medium of claim 14, wherein the at least one type of model to be created includes at least one of an end of an asset's economic life model, an unexpected degraded operation model, an unplanned outage model, an un-planned maintenance model, or a planned maintenance model.

22. The machine-readable medium of claim 14, wherein preparing the received data comprises at least one of an interpretation of the received data, performing quality control of the received data, or a subject matter expert (SME) evaluation of the received data.

23. The machine-readable medium of claim 22, wherein the SME provides the evaluation of the received data via a questionnaire.

24. A system for creating an asset reliability model for at least one physical asset, comprising:
at least one data source;
a computing device comprising a processor and a memory having stored therein at least one program, the at least one program including instructions which, when executed by the processor, cause the computing device to perform a method, comprising:
receiving data related to the at least one physical asset from at least a selection of at least one data source from which to receive the data related to the at least one physical asset;
receiving a selection of at least one type of model to be created;
receiving a respective response to at least one guided task or choice configured to prepare the received data related to the at least one physical asset to be used to create the selected model type; and
creating an asset reliability model for the at least one physical asset using a machine learning process based on the received data related to the at least one physical asset, the selection of the model to be created, and the respective response to the at least one guided task or choice.

25. The system of claim 24, wherein the method further comprises:
allocating resources for performing maintenance on the at least one physical asset based on the determined reliability model.
